(19) United States
(12) Patent Application Publication
(10) Pub. No.: US 2004/0089087 A1
(43) Pub. Date: May 13, 2004

(54) Gearbox for a vehicle

(76) Inventors: Wolf-Ekkehard Krieg, Lehnin (DE); Michael Ebenhoch, Friedrichshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/696,413

(22) Filed: Oct. 28, 2003

(30) Foreign Application Priority Data
Nov. 2, 2002 (DE) 102 50 970.0

(51) Int. Cl. F16H 3/08

(52) U.S. Cl. 74/329

(57) ABSTRACT

A drive train (24) of a motor vehicle with a front engine (2) and rear-wheel or all-wheel drive, in which a gear input shaft (26) from a drive technical point of view is connected to a front engine (2) and a gear output shaft (38) is connected via a longitudinal drive shaft (61) to the rear axle gearbox and in which gear wheels (27, 28; 29, 30; 31, 32; 33, 34) meshing with one another are arranged on the gear shafts, wherein for every gear transmission ratio, one gear wheel is arranged in a torsionally stationary manner on the gear shaft (26), while the respectively other gear wheel is pivotably seated on another gear shaft (38) and via coupling mechanisms (25, 35) can be connected to the gear shaft (38) that is assigned to the idler wheels (28, 30, 32, 34). In order to implement a cost effective gearbox with very compact dimensions, the design is constructed so that the gear input shaft (26) and the gear output shaft (38) have such an offset (a, b) in relation to one another that both of the shafts (26, 38) are not aligned coaxially to one another.

The invention relates to a gearbox for a motor vehicle with the characteristics of the preamble to patent claim 1.

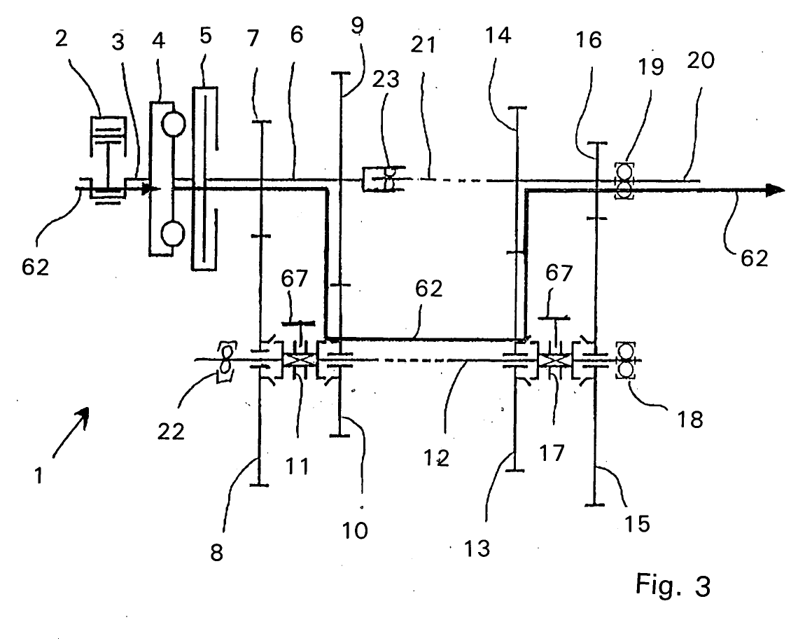

Such gearboxes are commonly known and are installed in vehicles having front longitudinally arranged engines and rear- or all-wheel drive. FIG. 3 shows such a gearbox that is designed as a mechanically geared transmission, which is equipped with a gear input shaft, a countershaft and a gear output shaft.

Of particular importance, as it relates to this invention, is that gearboxes of this type are designed such that the input and output shafts are aligned coaxially in relation to each other. This arrangement has advantages, however, the disadvantage is that with a mechanically geared transmission the absolutely necessary axial offset to the countershaft must be mechanically reversed so that the coaxial gear output, in relation to the gear input, is possible. This causes disadvantages, especially as it relates to production costs, the necessary assembly space and the weight of such a gearbox. In addition, th degree of effectiveness is lessened due to the added engagement of gear wheels on the respective shafts.

The purpose of the invention is, therefore, to present a vehicle gearbox that does not exhibit the above mentioned disadvantages and is built on a small scale as well as has a better degree of effectiveness.

The solution to the task is found in the characteristics of the main claim whereas advantageous embodiments and further improvements of the gearbox are part of the dependent claims.

The previously mentioned disadvantages of the known gearboxes are thereby avoided in a gearbox with the gear input and output shafts arranged in such a way inside the gearbox housing that they are axially offset and are not aligned to one another coaxially. Getting away from the previously customary gearbox structure with mechanically geared transmissions enables, above all, the construction of smaller and lighter gearboxes without having to give up the gear ratio characteristics of such a gearbox.

The gearbox, as it relates to the invention, in addition allows for the gear input and output shafts to be parallel to the axis, although gearboxes not having axially parallel shaft constructions are feasible and may possibly be advantageous.

In regards to the arrangement of idler and fixed wheels as well as to the coupling devices for the idler wheels on the gear shafts, a different variation of a coupling device can be implemented as well. For example, the idler wheels and the coupling device may be arranged on the gear input and/or output shaft, although the arrangement of the idler wheels and the coupling devices on only one of the two gear shaft, especially on the gear output shaft, is considered beneficial.

The coupling devices as such may be designed as claw couplings of sliding sleeves that are axially displaceable on the gear shaft which, for the purpose of synchronization in a familiar way, interact either with a gear shaft brake or with synchronizing devices that are arranged between the sliding collar sleeve and the respective gear wheel.

In a further design, as it relates to the invention, a countershaft is installed coaxially to the gear output shaft in the gearbox, wherein on said shaft at least one gear wheel is installed, preferably in a stationary manner. In addition, the countershaft may be designed as a hollow shaft and be utilized to hold the gear output shaft or be seated in a hollow section of the gear output shaft.

In regards to the axial offset and the arrangement of the gear shafts in the gearbox housing in a further development of the invention, it is considered especially advantageous to have the longitudinal drive shaft (i.e., a cardan shaft) that can be attached to the gear output shaft arranged beneath the gear input shaft as it relates to the assembly position of the gearbox in the body of a motor vehicle.

This way, the gear offset makes doing without the cardan tunnel possible in the body of a vehicle, which is present in vehicles with front engines and rear-wheel drive or all-wheel drive. Moreover, as a result of the possibility of lowering the longitudinal drive shaft, it is possible that the center of gravity of the vehicle is lowered much further, thus improving the driving characteristics of the vehicle.

For example, in order to keep the connection point of the cardan shaft at the rear axle transmission of an existing type of vehicle, the cardan shaft can also be slightly inclined compared to the conventional arrangement in such motor vehicles. In taking such measures, there are no disadvantages with regards to the clearance underneath the vehicle.

In another design, as it relates to the invention, the axial offset, as well as the arrangement of the gear shafts inside the gearbox housing, are designed in such a way that a longitudinal drive shaft (cardan shaft) that is fastened to the gear output shaft is arranged above the gear input shaft as it relates to the installation position of the gearbox in the body of the motor vehicle. The advantage of this gearbox design is that the lowering of the engine of the vehicle leads to an even greater downward shift of the center of gravity. The lowering of the engine increases crash safety and protection of the passengers as it relates to a head-on collision with the vehicle.

The gearbox, as it relates to the invention, may be used as a purely manual transmission, as an automatic transmission, or as a double clutch transmission whereby the double clutch transmission is preferably equipped with two gear input shafts that are arranged coaxially to one another.

In case the gearbox is designed as an automatic transmission or a double clutch transmission, the coupling devices, meaning generally the sliding sleeves of the gearbox, are designed in yet another way as they relate to the invention such that they can be actuated automatically by means of adjusting devices actuated by auxiliary controls such as a hydraulic centering actuator and/or be actuated manually.

The design of the gearbox as it relates to the invention is best described by means of concrete design examples as well as by comparisons to a known countershaft as illustrated by the attached figures as follows:

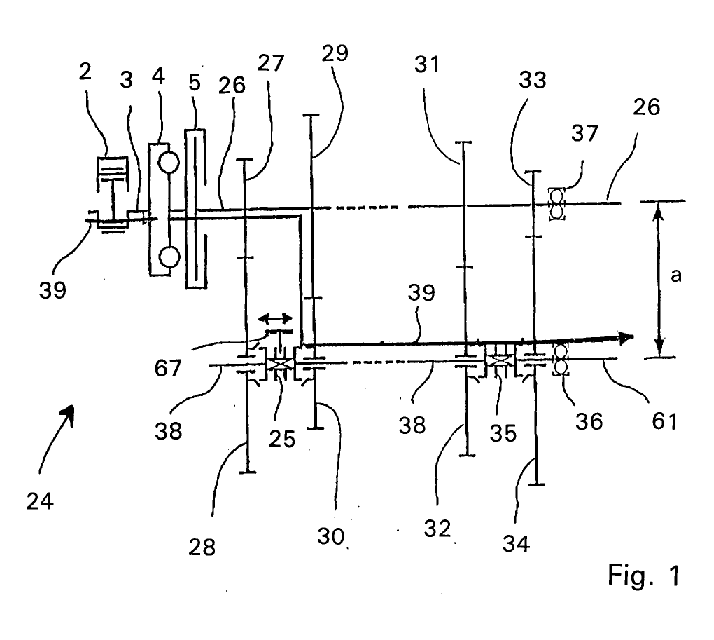

FIG. 1 is a diagrammatic view of a gearbox with a gear output shaft lowered to the bottom;

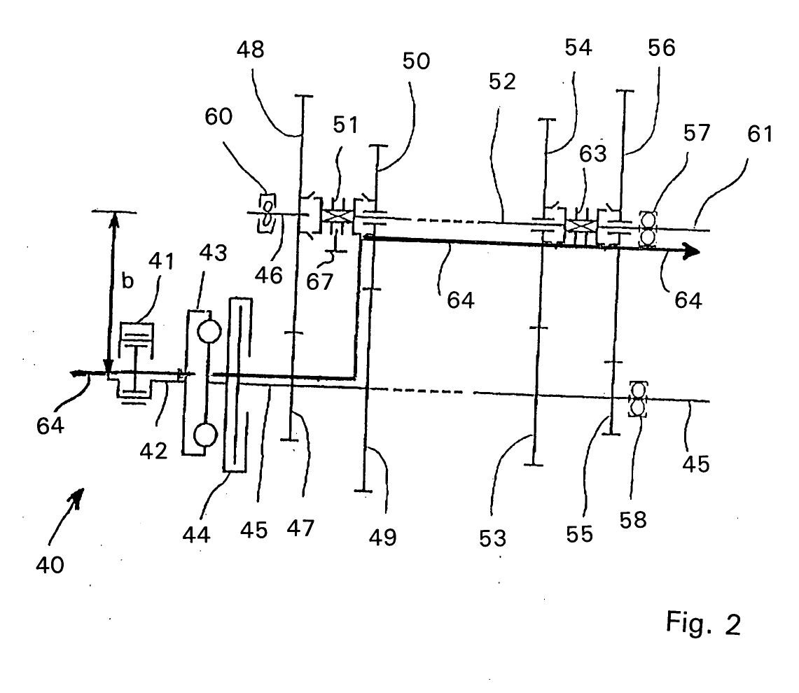

FIG. 2 is a diagram like FIG. 1, however, with a gear input shaft lowered to the bottom;

FIG. 3 is a diagrammatic view of a gearbox with a countershaft as it relates to the state of the art; and

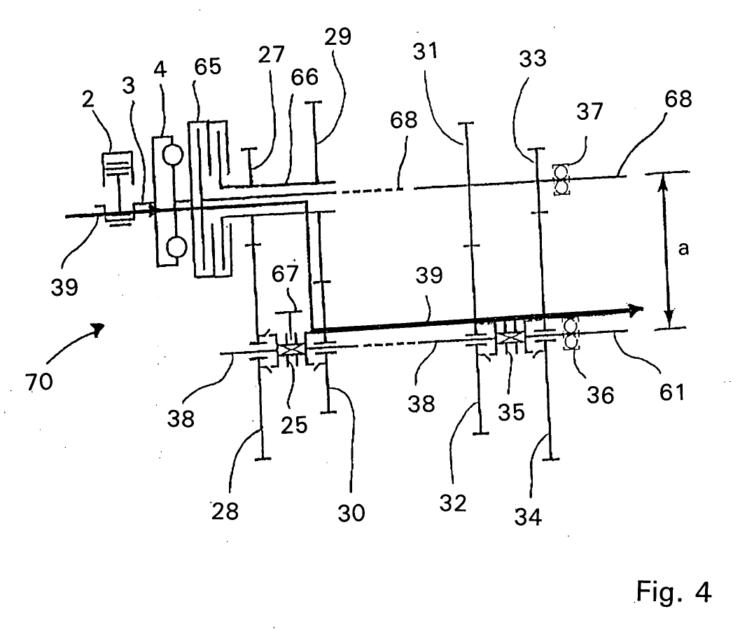

FIG. 4 is a double clutch transmission with a similar gearbox as the transmission in FIG. 1.

FIG. 3 clearly shows that a drive train 1 of a familiar manual transmission is powered by a driving engine with a mechanically geared transmission design, with the engine (shown here) as being an internal combustion engine. The crankshaft 2 of the driving engine is connected with a torsional vibration damper 4 with which rotational irregularities of the driving engine can be compensated.

Behind the torsional vibration damper 4, from a drive system point of view, a start up and shifting clutch 5 is arranged, whose output part is connected to the gear input shaft 6 of the mechanically geared transmission.

Two gear wheels 7, 9 are wedged in a stationary manner on the gear input shaft 6, which comb gear wheels 8, 10 that can be rotated on a mechanically geared transmission shaft 12. The mechanically geared transmission shaft 12 is stored in two holding device 18, 22 and carries idlers wheels 13, 15 that each have their own gear transmission ratio apart from the above mentioned idler wheels 8, 10. The mechanically geared transmission shaft 12 is additionally shown in its center area with dashes in order to illustrate that dependent on the number of gear transmission ratios more idler wheels can be arranged on the mechanically geared transmission shaft 12.

In order to achieve a stationary connection of each of the idler wheels 8, 10, 13, 15 and thus adjust a precise gear transmission ratio of the gearbox, coupling device 11, 17 shaped like sliding sleeves are arranged in a rotationally stationary, but axially displaceable manner on mechanically geared transmission shaft 12. By means of an adjusting device 67, the sliding sleeves are moved so far away axially when performing a concrete shifting operation in a usual manner towards the respective gear wheels 8, 10, 13, 15 until a torsionally stationary connection between each idler wheel and the mechanically geared transmission shaft 12 is established.

Apart from the gear input shaft 6 and the mechanically geared transmission shaft 12, the known gearbox is equipped with a gear output shaft 21 that is seated in a hollow shaft section 23 of the gear input shaft 6 and is seated in another bearing 19 coaxially to the gear input shaft 6. Gear wheels 14, 16 are affixed on the gear output shaft 6 and mesh with the idler wheels 13, 15 on the mechanically geared transmission shaft 12. This design facilitates the fact that a driving power 62 that is introduced into the transmission via the gear input shaft 6 can be passed on via the mechanically geared transmission shaft 12 and that gear output shaft 21, which is arranged coaxially to the gear input shaft 6, to a cardan shaft 20, which is connected to said gear output shaft 21.

Deviating from the known gearbox design, the designs of gearboxes in FIGS. 1, 2 and 4 as they relate to the invention allow for a much more compact and cost effective construction, which additionally is associated with the advantage that there is an axis offset between the gear input shaft and the gear output shaft as already described in the advantages regarding the shift of center of gravity and the smoothing of the vehicle body.

As FIG. 1 clarifies, the invented gearbox will, for example, also be powered by an internal combustion engine in a drive train 24. This engine's crankshaft 3 is connected from a drive point of view, via the torsional vibration damper 4 and the start up, and the shifting clutch 5 with the input shaft 26 of the transmission. A row of gear wheels (fixed wheels 27, 29, 31, 33) are attached to the gear input shaft 26. These gear wheels mesh with idler wheels 28, 30, 32, 34 on a gear output shaft 38.

To simplify the design, a journal bearing 36 for the gear output shaft 38 and a journal bearing 37 for the gear input shaft 26 are shown. The dotted illustration of the gear input shaft 26 and of the output shaft 38 indicates that, apart from the exemplary gear wheel sets 27, 28; 29, 30; 31, 32; 33, 34, additional transmission gears may be installed for additional gear wheel sets on the two shafts 26, 38.

When a disengaged start up and shifting clutch 5 the gear input shaft 26 will be driven by the driving engine 2 so that it can rotate together with the fixed wheels 27, 29, 31, 33. As the idler wheels 28, 30, 32, 34 are meshed with the mentioned fixed wheels as a function of the individual gears, these also loosely rotate along with them.

When activating a gear transmission ratio and, in the case of forwarding of a driving power 39 to a cardan shaft 61 that is connected to the gear output shaft 38, pursuant to the state of the art (FIG. 3), sliding sleeves 25, 35 that is assigned to the idler wheels will be moved axially as far as possible in the direction of the affected gear wheel until a mechanical coupling between the gear output shaft 38 and the respective idler wheel has been established.

As FIG. 1 shows a double shaft structure, as it relates to the invention, may cause a shaft offset with a distance “a”, by the length of which the cardan shaft of a vehicle is lowered deeper in the direction of the roadway than previously common, which is associated with the already mentioned advantages. Furthermore, this design of the gearbox allows considerable assembly space and weight to be saved.

FIG. 2 shows a gearbox structure that, likewise, follows the main idea of the invention. Here, as well as in a drive train 40, the gearbox is driven by an internal combustion engine 41, via its crankshaft 42, a torsional vibration damper 43 and a start up and shifting clutch 44, whereby, in this example, the internal combustion engine 41 of the vehicle is lowered in the direction of the road.

In this gearbox as well, fixed wheels 49, 53, 55 are wedged in a torsionally stationary manner on a gear input shaft 45 that is seated in a bearing 58. The fixed wheels mesh with idler wheels 50, 54, 56 on a gear output shaft 52 that is seated in bearings 57, 60. In order to have a torsionally stationary assembly of idler wheels with the gear output shaft 52, these gearboxes have coupling links that are also designed as sliding sleeves 51, 63, which are arranged axially displaceable on the gear output shaft 52 by means of the adjusting device 67.

Apart from lowering the gear input side with the drive engine 41, the torsional vibration damper 43 and the clutch 44, this variation of the invention as they relate to this new gearbox also has the special feature that a fixed wheel 47 on the gear input shaft 45 meshes with a fixed wheel 48, which is arranged on a mechanically geared transmission shaft 46. This mechanically geared transmission shaft 46 is aligned coaxially with the gear output shaft 52 and is seated in pivot bearing 60. Moreover, it is also possible to at least partially store the mechanically geared transmission shaft 46 in a hollow shaft section of the gear output shaft 52. The technical drive-related connection of the fixed wheel 48 with gear output shaft 52 is accomplished by means of the sliding sleeve 51, which for this is arranged on the gear output shaft 52 so as to be moved axially in the direction of this gear wheel 48.

Furthermore, the gear output shaft 52 is connected with a cardan shaft 61, so that it is possible to transfer a driving power 64 that is introduced into the transmission on the gear input shaft 45 with the desirable axial offset “b” to a rear axle or all-wheel drive transmission.

Finally, in FIG. 4, a drive train 70 is shown with a double clutch transmission. The design of this double clutch transmission largely conforms to the gearbox shown in FIG. 1 so that many gearbox parts can be utilized in the same way for both gearbox types. A significant difference relates to the input areas of both gearboxes as the double clutch transmission has gear input shafts 66, 68, which are seated coaxially to one another, with respectively assigned fixed wheels 27, 29, 31, 33. Each of the gear input shaft 66, 68 is attributed a part of a double clutch 65, so that both of the input shafts 66, 68 can be connected to the internal combustion engine 2 from a drive technical point of view independent from one another.

In an embodiment of the invention that is not shown, the double clutch transmission is constructed with regard to the arrangement of the shafts as shown in the gearbox in FIG. 2. In this way, the driving engine 2 and, as the case may be, the torsional vibration damper 4 and the double clutch 65 and the gear input shafts 66, 68 are arranged below the gear output shaft 52.

### Reference Numerals

1 drive train

2 driving engine

3 crankshaft

4 torsional vibration damper

5 clutch

6 gear input shaft

7 fixed wheel

8 idler wheel

9 fixed wheel

10 idler wheel

11 coupling device, sliding sleeve

12 mechanically geared transmission shaft

13 idler wheel

14 fixed wheel

15 idler wheel

16 fixed wheel

17 coupling device, sliding sleeve

18 holding device, bearing

19 bearing

20 cardan shaft

21 gear output shaft

22 bearing

23 hollow shaft

24 drive train

25 sliding sleeve

26 gear input shaft

27 fixed wheel

28 idler wheel

29 fixed wheel

30 idler wheel

31 fixed wheel

32 idler wheel

33 fixed wheel

34 idler wheel

35 sliding sleeve

36 bearing

37 bearing

38 gear output shaft

39 driving power

40 drive train

41 drive engine

42 crankshaft

43 torsional vibration damper

44 clutch

45 gear input shaft

46 auxiliary shaft

47 fixed wheel

48 fixed wheel

49 fixed wheel

50 idler

51 sliding sleeve

52 gear output shaft

53 fixed wheel

54 idler wheel

55 fixed wheel

56 idler wheel

57 bearing

58 bearing

59 bearing

60 bearing

61 cardan shaft

62 driving power

63 sliding sleeve

64 driving power

65 double clutch

66 hollow shaft; gear input shaft

67 adjusting device

68 gear input shaft

69 drive train

70 train

a offset

b offset

1. Gearbox for a drive train of a motor vehicle with a front engine (2, 41) and rear-wheel or all-wheel drive, in which a gear input shaft (26, 45, 66, 68) is technically driven by the front engine and a gearbox output shaft (38, 52) from a drive technical point of view is connected with the front engine and a gear output shaft (38, 52) is connected via a longitudinal drive shaft (61) to a rear axle gearbox, and in which gear wheels combing gear shafts are arranged, of which for each gear transmission ratio a gear wheel is seated on one of the gear shafts in a torsionally stationary manner, while the other gear wheel, respectively, is pivotably seated on another gear shaft and by means of a coupling mechanism (25, 35, 51, 63) can be connected to a gear shaft that is assigned to said idler wheels, characterized by the fact that the gear input shafts (26, 45, 66, 68) and output shaft (38, 52) have such an axial offset (a, b) that both shafts are not aligned coaxially to one another.

2. Gearbox according to claim 1, characterized by having the gear input shaft (26, 45, 66, 68) and the gear output shaft (38, 52) arranged axially parallel to one another.

3. Gearbox according to claim 1 or claim 2, characterized by having idler wheels and the coupling mechanism (25, 35, 51, 63) arranged on the gear input shaft (26, 45, 66, 68) and/or on the gear output shaft (38, 52).

4. Gearbox according to claim 3, characterized by having the coupling mechanisms (25, 35, 51, 63) designed as claw coupling, sliding sleeves or synchronizing devices that are axially displaceable on the gear shaft.

5. Gearbox according to at least one of the previously mentioned claims, characterized by having a countershaft (46) coaxially attached to the gear output shaft (52) with at least one gear wheel (48), wherein said shaft can be connected by means of a coupling mechanism (51) to the gear outgoing output shaft (52).

6. Gearbox according to at least one of the previous claims, characterized by having the offset (a) as well as the arrangement of the gear shafts in the gearbox housing designed in such a way that a longitudinal drive shaft (61) that can be attached to the gear output shaft (38) is arranged beneath the gear input shaft (26, 66, 68) as it relates to the installation position of the transmission in the body of a motor vehicle.

7. Gearbox according to at least one of the claims 1 through 5, characterized in that the offset (b) as well as the arrangement of the gear shafts in the gearbox housing are arranged in such a way that a longitudinal drive shaft (61) that can be attached to the gear output shaft (52) is arranged above the gear input shaft (45, 66, 68) as it relates to the installation position of the transmission in the body of a motor vehicle.

8. Gearbox according to at least one of the previous claims, characterized by having the gearbox designed as a double clutch transmission, in which two gear input shafts (66, 68) are preferably arranged coaxially to one another in the gearbox housing.

9. Gearbox according to at least one of the claims from 1 through 8, characterized by being equipped with an automatically shifting transmission.

10. Gearbox according to at least one of the previous claims, characterized by having coupling mechanisms (25, 35, 51, 63) that are operated automatically or manually with adjusting devices (67).
